(19) United States
(12) Patent Application Publication
(10) Pub. No.: US 2013/0206907 A1
(43) Pub. Date: Aug. 15, 2013

(54) EXPANDABLE LAVATORY WITH MOVABLE WALL

(71) Applicant: C&D ZODIAC, INC., (US)

(72) Inventors: Ralph Burrows, Bellingham, WA (US); Christoph Goeschel, Seattle, WA (US); John Higgins, Bellingham, WA (US); Thomas Lee, Coto de Caza, CA (US); Herman Schotte, Hamburg (DE)

(73) Assignee: C&D ZODIAC, INC., Huntington Beach, CA (US)

(21) Appl. No.: 13/765,633

(22) Filed: Feb. 12, 2013

Related U.S. Application Data
(60) Provisional application No. 61/598,738, filed on Feb. 14, 2012.
(60) Provisional application No. 61/598,805, filed on Feb. 14, 2012.

(51) Int. Cl. B64D 11/02

(52) U.S. Cl. CPC B64D 11/02
USPC 244/118.5

(57) ABSTRACT

A lavatory monument assembly configured to be positioned in the interior of an aircraft that includes first, second, third and fourth walls that cooperate to define a lavatory interior, a door positioned on one of the first, second, third and fourth walls that allows access to the lavatory interior, and a toilet positioned within the lavatory interior. The toilet defines a first vertical plane that bifurcates the toilet and is positioned such that the first vertical plane is not parallel to the first wall. At least the first wall is pivotal between a stowed position and an expanded position. When the first wall is in the stowed position, the first, second, third and fourth walls define a first lavatory footprint and when it is in the expanded position, the first, second, third and fourth walls define a second lavatory footprint. The second lavatory footprint has a greater area than the first lavatory footprint.

### CROSS REFERENCE TO RELATED APPLICATIONS

This application claims the benefit of U.S. Provisional Application Nos. 61/598,738 and 61/598,805, both filed Feb. 14, 2012, which are herein incorporated by reference in their entireties.

### FIELD OF THE INVENTION

The present invention relates generally to aircraft lavatories and more particularly to an aircraft lavatory with a movable or pivotal wall.

### BACKGROUND OF THE INVENTION

Commercial aircraft, such as the Airbus A320 or Boeing 737 are typically constructed from modular components, the size, weight and construction of which are dictated by many considerations, including fuselage dimensions, aesthetic and safety considerations. Many of these requirements are imposed by law or regulation. Aircraft components, such as overhead stowage compartments, seats, lavatories, galleys, lighting systems, etc. are all required to function within strictly confined spaces.

Manufacturers of aircraft are constantly refining interior aircraft designs to achieve more comfort and utility for passengers and crew within carrier-imposed restraints on cost, weight, maintenance down-time, and safety. Commercial passenger aircraft generally include lavatories for use by passengers and crew.

Prior art aircraft lavatories are typically fixed structures with a rectangular footprint. There is usually a sink, toilet, mirror, and waste container in the lavatory. It is typically surrounded by composite panel walls that can be contoured to fit the aircraft curvature. The door is normally 20″ wide and can be a swinging door or a bi-fold one. The ceiling and mirror normally have integrated lighting. The entire monument is secured by floor fittings and ceiling tie rods. It is designed to conform to FAA loading standards. Multiple lavatories can be installed in the aircraft. See, for example, U.S. Pat. No. 6,079,669 to Hanay, et al., the entirety of which is incorporated by reference herein.

### SUMMARY OF THE PREFERRED EMBODIMENTS

In accordance with a first aspect of the present invention there is provided a lavatory monument assembly configured to be positioned in the interior of an aircraft that includes first, second, third and fourth walls that cooperate to define a lavatory interior, a door positioned on one of the first, second, third and fourth walls that allows access to the lavatory interior, and a toilet positioned within the lavatory interior. The toilet defines a first vertical plane that bifurcates the toilet and is positioned such that the first vertical plane is not parallel to the first wall. At least the first wall is pivotal between a stowed position and an expanded position. When the first wall is in the stowed position, the first, second, third and fourth walls define a first lavatory footprint and when it is in the expanded position, the first, second, third and fourth walls define a second lavatory footprint. The second lavatory footprint has a greater area than the first lavatory footprint. In a preferred embodiment, the first wall includes a first wall portion and a second wall portion, and the first wall includes at least first, second and third movable portions, such that the first wall portion and the second wall portion are movable relative to one another. Preferably, the door is positioned on the first or the second wall portion. However, the door can be positioned on any of the first, second or third walls, in a preferred embodiment, a sink is positioned therein on one or both of the second or third walls. In a preferred embodiment, the first wall includes an angled wall segment that extends inwardly therefrom that is in slidable communication with the second wall, such that when the first wall portion is pivoted from the stowed position to the expanded position, the angled wall segment translates and slides relative to the second wall.

In a preferred embodiment, when the first wall is in the stowed position a first passenger footprint is defined within the lavatory interior and when the first wall is in the expanded position a second passenger footprint is defined within the lavatory interior. The second passenger footprint is larger than the first passenger footprint. Preferably, the toilet is accessible to a passenger both when the first wall is in the expanded position and when the first wall is in the stowed position.

In accordance with another aspect of the present invention there is provided an aircraft that includes a cabin having a side wall that includes at least one exit door that includes an exit corridor adjacent thereto. The exit corridor includes an exit corridor footprint. The aircraft also includes a lavatory monument assembly positioned within the cabin and that includes first, second, third and fourth walls that cooperate to define a lavatory interior, a door positioned on one of the first, second, third and fourth walls that allows access to the lavatory interior, and a toilet positioned within the lavatory interior. The toilet defines a first vertical plane that bifurcates the toilet and is positioned such that the first vertical plane is not parallel to the first wall. At least the first wall is pivotal between a stowed position and an expanded position. When the first wall is in the stowed position, the first, second, third and fourth walls define a first lavatory footprint and when the first wall is in the expanded position, the first, second, third and fourth walls define a second lavatory footprint. The second lavatory footprint has a greater area than the first lavatory footprint. In a preferred embodiment, the lavatory monument assembly is positioned adjacent to the exit door, and the first wall defines a portion of the exit corridor. When the first wall is in the expanded position, the second lavatory footprint overlaps with the exit corridor footprint.

In accordance with another aspect of the present invention there is provided a method that is performed in the cabin of an aircraft that includes a lavatory monument assembly positioned therein. The cabin further includes a side wall with at least one exit door that includes an exit corridor adjacent thereto that defines an exit corridor footprint. The method includes pivoting a first wall of the lavatory monument assembly between a stowed position and an expanded position. When the first wall is in the stowed position, the lavatory monument assembly defines a first lavatory footprint and when the first wall is in the expanded position, the lavatory monument assembly defines a second lavatory footprint. The second lavatory footprint has a greater area than the first lavatory footprint. The lavatory monument assembly includes a toilet positioned therein that defines a first vertical plane that bifurcates the toilet and that is not parallel to the first wall when it is in the stowed position. Preferably, the first wall is in the stowed position during taxi, takeoff and landing and in the expanded position during the remainder of the flight and the toilet is accessible by a passenger when the first wall is in the stowed position and when the first wall is in an expanded position.

In accordance with yet another aspect of the present invention there is provided a lavatory monument assembly that is configured to be positioned in the interior of an aircraft. The lavatory monument assembly includes first, second, third and fourth walls that cooperate to define a lavatory interior and a fifth wall that spans between and is affixed to the second and fourth walls and that divides the lavatory interior into a first lavatory and a second lavatory. The lavatory monument assembly also includes a first door positioned on one of the first, second, third and fourth walls that allows access to the first lavatory, and a second door positioned on one of the first, second, third and fourth walls that allows access to the second lavatory. The first wall is pivotal between a stowed position and an expanded position. When the first wall is in the stowed position, the first, second, third and fourth walls define a first lavatory footprint and when the first wall is in the expanded position, the first, second, third and fourth walls define a second lavatory footprint. The second lavatory footprint has a greater area than the first lavatory footprint. In a preferred embodiment, the portion of the fifth wall that is affixed to the second wall is not parallel to the first wall when it is in the stowed position. Preferably, a first portion of the fifth wall is not parallel to the first wall and a second portion of the fifth wall is parallel to the fifth wall. In a preferred embodiment, the first lavatory includes a first sink positioned therein and the second lavatory includes a second sink positioned therein, and the first and second sinks are affixed to the fifth wall and include shared plumbing. Preferably, the lavatory monument assembly includes a first toilet positioned in the first lavatory and a second toilet positioned in the second lavatory. The second toilet defines a vertical plane that bifurcates the toilet and is positioned such that the vertical plane is not parallel to the first wall when it is in the stowed position.

### BRIEF DESCRIPTION OF THE DRAWINGS

FIG. 1 is a perspective view of a lavatory monument assembly in accordance with a preferred embodiment of the present invention with the movable wall in a stowed position;

FIG. 2 is a perspective view of the lavatory monument assembly of FIG. 1 with the movable wall in an expanded position;

FIG. 3 is a top plan view of the lavatory monument assembly of FIG. 1 with the movable wall in the stowed position;

FIG. 3A is a top plan view of the lavatory monument assembly of FIG. 1 with the movable wall in the expanded position;

FIG. 4 is a top plan view of another embodiment of a lavatory monument assembly with the movable wall in the stowed position;

FIG. 4A is a top plan view of the lavatory monument assembly of FIG. 4 with the movable wall in the expanded position;

FIG. 5 is a top plan view of the aft portion of an aircraft cabin with two lavatory monument assemblies installed therein;

FIG. 6 is another top plan view of the aft portion of an aircraft cabin with two lavatory monument assemblies installed therein with the movable walls in a stowed position;

FIG. 6A a top plan view similar to FIG. 6, but with the movable walls in an expanded position;

FIG. 7 is a top plan view of a dual lavatory monument assembly with a movable wall in stowed position in accordance with a preferred embodiment of the present invention;

FIG. 7A is a top plan view of the dual lavatory monument assembly of FIG. 7 with the movable wall in the expanded position;

FIG. 8 is a perspective view of another embodiment of a dual lavatory monument assembly; and

FIG. 9 is a top plan view of the aft portion of an aircraft cabin with a dual lavatory monument assembly installed therein.

### DETAILED DESCRIPTION OF TILE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

Referring now to the drawings, wherein the showings are for purposes of illustrating the present invention and not for purposes of limiting the same, FIGS. 1-6 show an embodiment of a lavatory assembly 10 with a pivotal or movable first wall 16. In particular, the invention is contemplated for use on commercial passenger aircraft 100. However, this is not a limitation on the present invention and the lavatory assembly can be used elsewhere.

In a preferred embodiment, the lavatory monument assembly 10 is configured to be located in the aft section of the cabin 102 of the aircraft 100, forward of the exit door 104 (as shown in FIG. 5) and/or in the front of the aircraft 100 next to the exit door 104. However, this is not a limitation on the present invention.

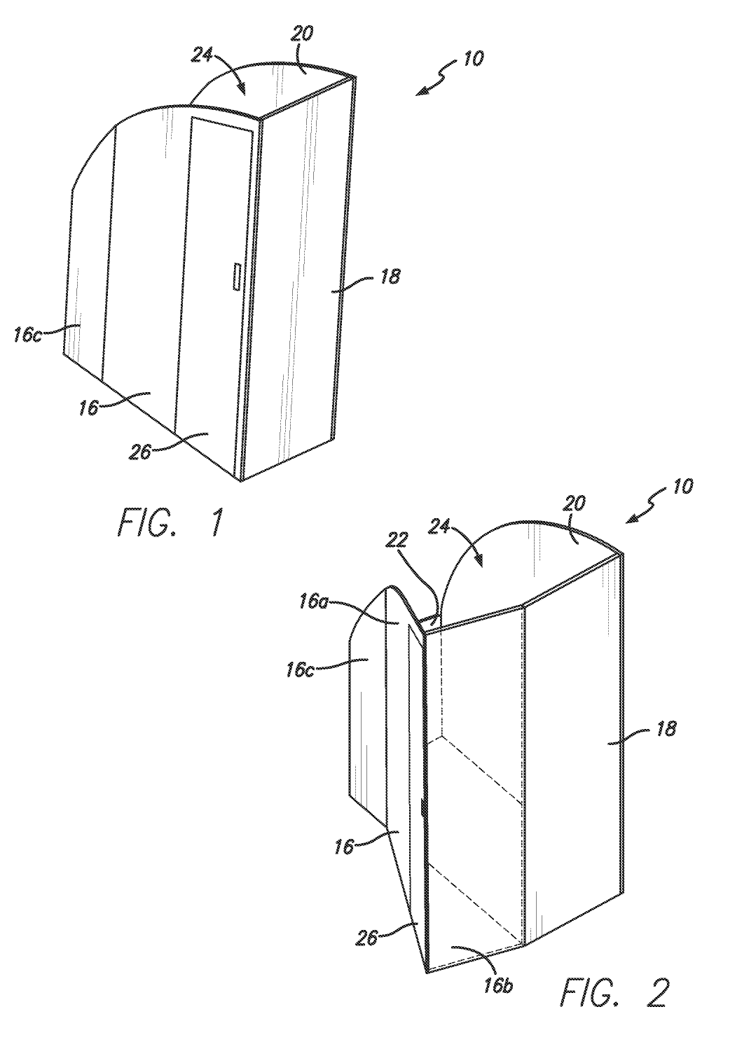

In a preferred embodiment, the lavatory monument assembly 10 comprises a single lavatory monument that includes a lavatory 12. As shown in the figures, the lavatory monument assembly 10 includes a first wall 16 that expands the usable volume of the lavatory 12. The rotating wall or first wall 16 can be locked or secured in either a stowed (see FIG. 1) or expanded (see FIG. 2) position. For example, the first wall 16 can include a latch that mates with a latch or opening on the floor of the cabin to secure the first wall 16 in the expanded position. In another embodiment, the wall 16 can be part of a substructure that includes the floor and the ceiling of the cabin 102. The entire substructure can rotate about or along movable portion 14. Once opened, the fixed structure can be locked in place.

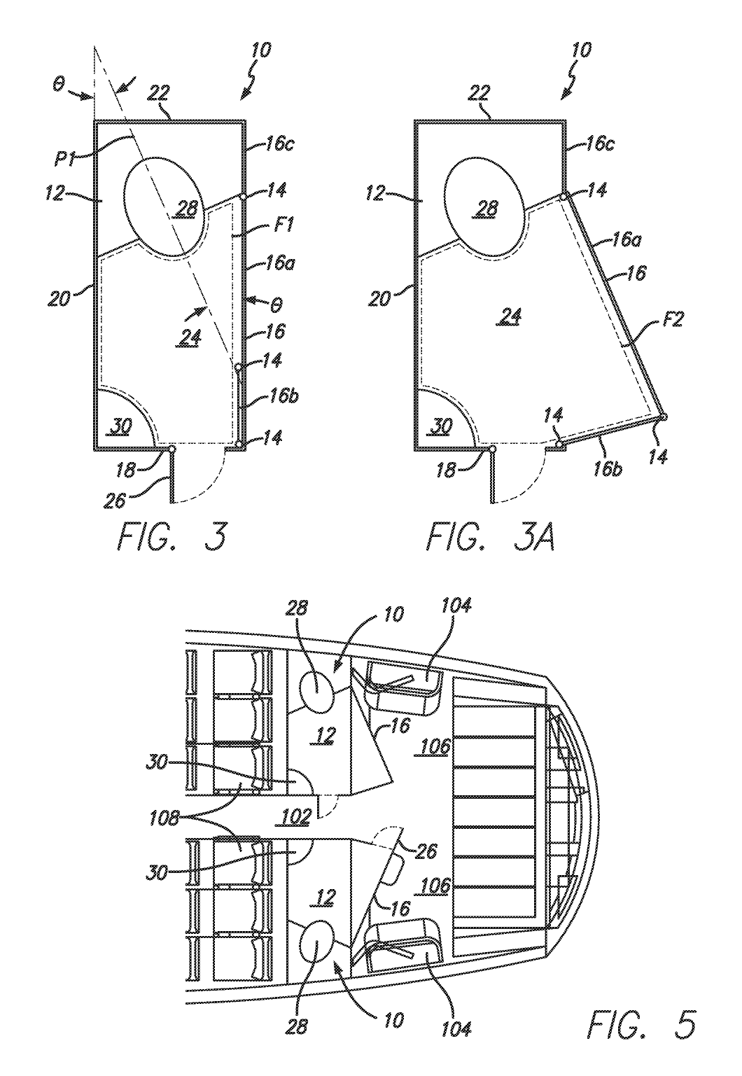

In a preferred embodiment, the lavatory monument assembly 10 includes first, second, third and fourth walls 16, 18, 20 and 22 that cooperate to define a lavatory interior 24, and a door 26 positioned on one of the first, second, third and fourth walls 16, 18, 20 and 22 that allows access to the lavatory interior 24. As discussed above, at least the first wall 16 is pivotal between a stowed position and an expanded position. In a preferred embodiment, the first wall 16 pivots in order to increase the volume and footprint of the lavatory 12. With reference to FIGS. 3 and 3A, when the first wall 16 is in the stowed position (FIG. 3), the first, second, third and fourth walls 16, 18, 20 and 22 define a first lavatory footprint and when the first wall 16 is in the expanded position (FIG. 3A), the first, second, third and fourth walls 16, 18, 20 and 22 define a second lavatory footprint. As will be appreciated by those of ordinary skill in the art, the second lavatory footprint has a greater area than the first lavatory footprint. It will be understood that with the door 26 closed, that the first and second lavatory footprints have a closed area. In other words, simply opening or pivoting the door is not what creates the second lavatory footprint, but that the lavatory monument assembly 10 includes a first wall 16 and a door 26.

In a preferred embodiment, the first wall 16 can include hinges, latches, sliders and the like (referred to herein generally as movable portions 14) that allow the first wall 16 to move, pivot, slide, translate, etc. relative to the other walls. For example, see U.S. Pat. No. 6,079,669 to Hanay (the “'669 patent”), the entirety of which is incorporated by reference herein. In one embodiment, the movable first wall 16 can include multiple panels or wall portions (e.g., first wall portion 16a and second wall portion 16b) that pivot and/or slide relative to one another (similar to the way a bi-fold door in a standard aircraft lavatory does) between expanded and stowed positions. The first wall 16 can also include a third wall portion 16c that does not move. The door 26 can be part of one of the first, second of third wall portions 16a, 16b or 16c.

The door 26 that allow access to the lavatory interior 24 can be located on any of the first, second, third or fourth walls 16, 18, 20 and 22. FIG. 5 shows the door 26 in two different places on the two different lavatory monument assemblies 10.

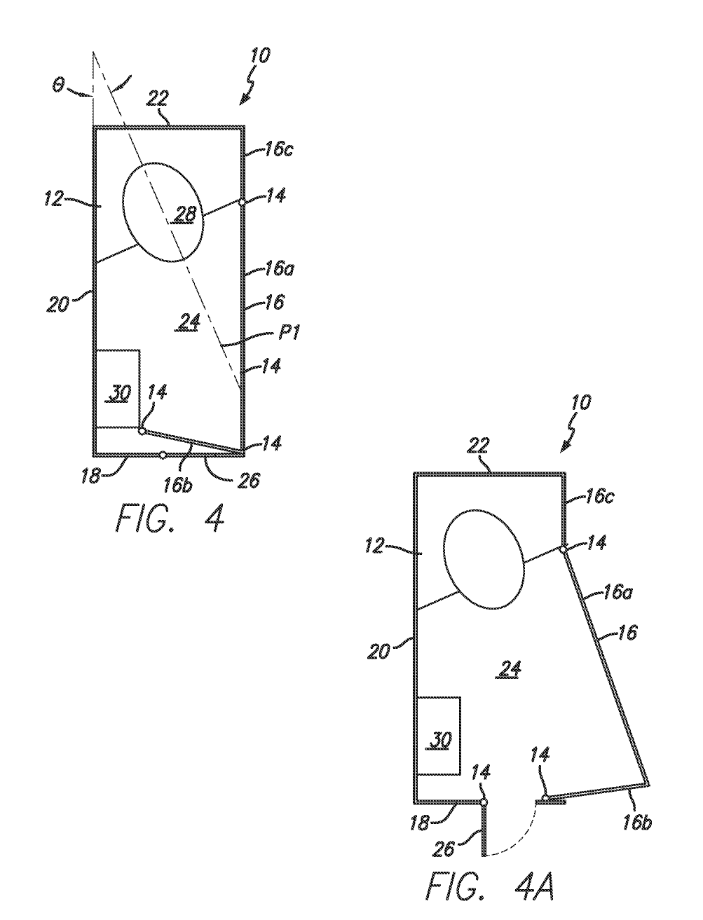

As is shown in FIG. 5, in an exemplary embodiment, the lavatory monument assembly 10 is 25″ wide, a common aircraft seat length, and extends inboard to the aisle so it is in-line with the row of seats 108. However, this dimension is not a limitation on the present invention. In a preferred embodiment, the lavatory monument assembly 10 includes a toilet 28 positioned outboard and facing inboard, and a sink 30 that is positioned in the inboard corner. Preferably, the toilet 28 is positioned such that it is angled, as is best shown in FIGS. 3-4A. In other words, the toilet 28 is angled such that a vertical plane P1 that bifurcates the toilet 28 is non-parallel to and forms an angle θ with the first wall 16 and or the third wall 20. This allows a passenger seated on the toilet 28 to use the extra space created by the first wall 16, after it is moved. However, this is not a limitation on the present invention.

The angled toilet orientation together with the movable first wall 16 also provides for increased area for passengers when using the toilet (referred to herein as “passenger footprint”). For example, as shown in FIG. 3, before the first wall 16 is pivoted, the lavatory monument assembly 10 defines a first passenger footprint F1. As shown in FIG. 3A, after the first wall 16 is pivoted, the lavatory monument assembly 10 defines a second passenger footprint F2, which has a larger area than the first passenger footprint F1. In a preferred embodiment, due to the placement of the door 26, the lavatory is usable in both configurations. It will be appreciated by those skilled in the art that the first and second lavatory footprints are defined by the floor area occupied by the entire lavatory monument assembly 10 and the first and second passenger footprints are defined by the area of the floor within the lavatory monument assembly 10 that is usable by a passenger.

As shown in FIGS. 4-4A, in a preferred embodiment, the second portion 16b of the first wall 16 is an angled wall segment that extends inwardly from the first portion 16a and that is in slidable communication with the second wall 18 (see movable member 14), such that when the first wall 16 is pivoted from the stowed position to the expanded position, the angled wall segment 16b translates and slides relative to the second wall 18.

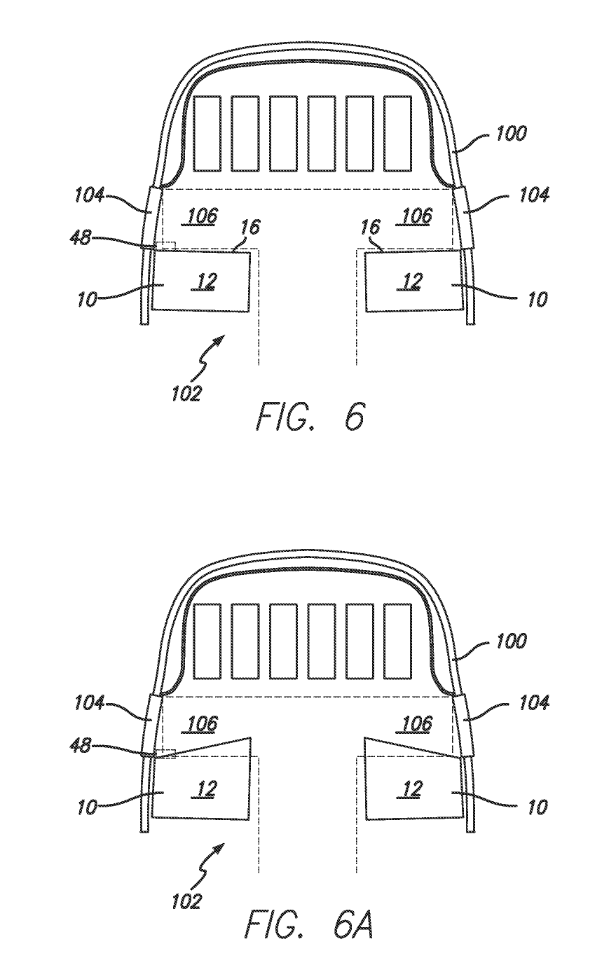

With reference to FIGS. 6-6A, in a preferred embodiment, the lavatory monument assembly 10 is positioned adjacent to the exit door 104. FIGS. 6 and 6A show the passenger walking area or exit corridor footprint 106 in hidden lines. In a preferred embodiment, a portion of the exit corridor footprint 106 id defined by the first wall 16. FIGS. 6-6A also show the flight attendant assist space 48 that is required on most aircraft. FIG. 6A shows that the assist space 48 is preserved even when the first wall 16 is in the expanded position. This allows the lavatory monument assembly 10 to be positioned as aft as possible (when in the back of an aircraft) to maximize seating.

In an exemplary use, the first wall 16 is in the stowed position during taxi, takeoff and landing. In this position, the lavatory 12 is usable, but space inside is limited. After the aircraft has taken off and reached the desired height (typically 10,000 ft), a flight attendant or other person deploys the first wall 16, moves it from the stowed position (the first lavatory footprint) to the expanded position (the second lavatory footprint) and secures it in place. More space is now available in the lavatory 12. When the aircraft is preparing for landing, a flight attendant or other person can once again move the first wall 16 to the stowed position.

As shown in FIG. 6A, and as will be understood by those of ordinary skill in the art, that when the first wall 16 is in the expanded position, the second lavatory footprint extends into and overlaps with the exit corridor footprint 106. Accordingly, the lavatory monument assembly 10 utilizes space that is normally wasted during flight. However, when the first wall 16 is in the stowed position it does not overlap with the exit corridor footprint 106. This adheres to FAA emergency exit rules. In other words, the exit corridor footprint 106 is only partially blocked or overlapped when the aircraft is in flight. During taxi, takeoff and landing, the exit corridor footprint 106 is not partially blocked or overlapped.

Those of ordinary skill in the art will appreciate when the first wall 16 is in the stowed position, the footprint defined by the lavatory monument assembly 10 can be smaller than the footprint of a typical lavatory. When the lavatory monument assembly 10 is positioned in the aft of the cabin 102, as shown in FIG. 5, this allows the lavatory monument assembly 10 to be moved aft compared to prior art lavatories, thus creating more space for extra seats 108. Furthermore, as can be seen in FIGS. 3 and 3A, the angled toilet 28 orientation, and increased user space created when the first wall 16 is in the expanded position, allow for increased comfort and user space in a small footprint lavatory 12.

Within the cabin 102, use of the lavatory monument assembly 10 can result in the addition of rows. In a standard commercial aircraft, there is a finite amount of longitudinal space between the wings and the rear of the aircraft. By moving the lavatory monument assembly 10 aft compared to a typical lavatory, a row or more can be added. In the stowed position, the first wall 16 provides enough exit corridor footprint 106 space to meet FAA regulations. In flight, the first wall 16 protrudes into exit space that is typically wasted.

It will appreciated that the lavatory monument assembly 10 does not have to be positioned near an exit door and that as used herein the term exit corridor footprint can be any corridor adjacent the movable first wall of the lavatory monument assembly.

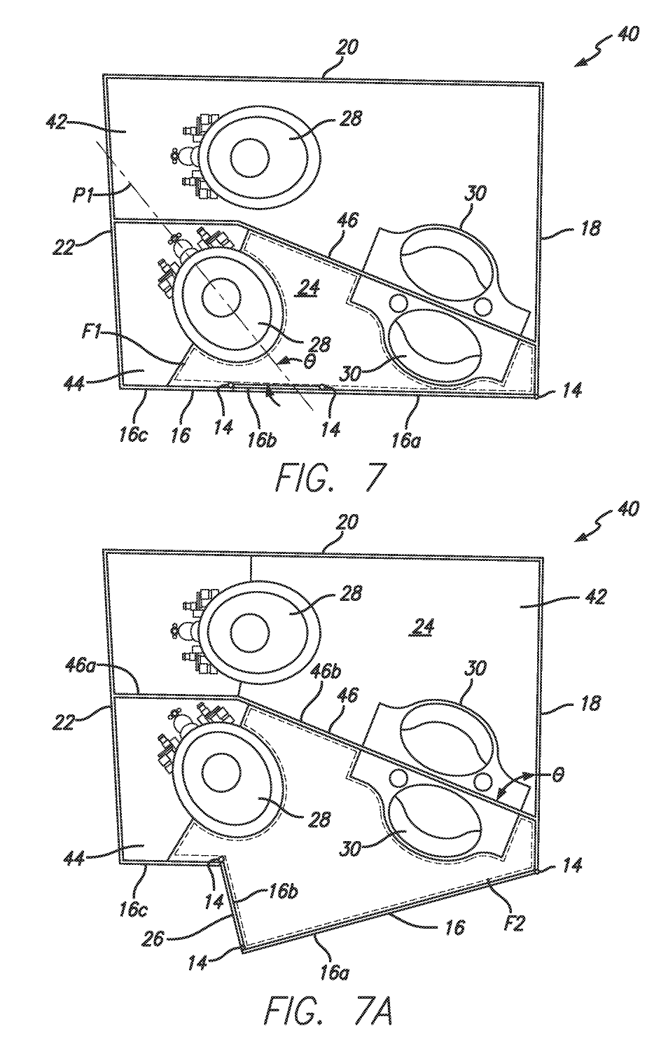

FIGS. 7-9 show an embodiment of a lavatory monument assembly 40 with a first wall 16 and that includes first and second lavatories 42 and 44. As shown in FIG. 7, in a preferred embodiment, the lavatory monument assembly 40 includes first 42 and second 44 lavatories that are configured within a single assembly, monument or unit with shared walls and loading capabilities. Lavatory monument assembly 40 includes first, second, third and fourth walls 16, 18, 20 and 22 that cooperate to define a lavatory interior 24 and a fifth wall 46 that spans between the second wall 18 and fourth wall 22 and that divides the lavatory interior 24 into the first lavatory 42 and the second lavatory 44. The lavatory monument assembly 40 also includes a first door 26 positioned on one of the first, second, third and fourth walls 16, 18, 20 and 22 that allows access to the first lavatory 42 and a second door 26 positioned on one of the first, second, third and fourth walls 16, 18, 20 and 22 that allows access to the second lavatory 44. Similar to the embodiment described above, the first wall 16 is movable or pivotal between a stowed position and an expanded position. When the first wall 16 is in the stowed position, the first, second, third and fourth walls 16, 18, 20 and 22 define a first lavatory footprint, and when the first wall 16 is in the expanded position, the first, second, third and fourth walls 16, 18, 20 and 22 define a second lavatory footprint. The second lavatory footprint has a greater area than the first lavatory footprint.

As shown in FIG. 7, in a preferred embodiment the first and second lavatories 42 and 44 include toilets 28 and sinks 30 and further include other components known in aircraft lavatories. In a preferred embodiment, the lavatory monument assembly 40 includes plumbing and electronics/power that are shared between the first and second lavatories 42 and 44. For example, the assembly can include a shared water heater, shared plumbing system, shared waste system, and shared power system. This reduction in components creates extra space that can be added to the interior of the first and second lavatories 42 and 44 or outside the first and second lavatories 42 and 44 so that seating 108 can be added into the cabin 102. However, this is not a limitation on the present invention and the first and second lavatories 42 and 44 can include separate plumbing and electronics/power. As shown in FIGS. 7-7A, in a preferred embodiment, the sinks 30 in the first and second lavatories 42 and 44 are both affixed to opposite sides of the fifth wall 46. This provides an opportunity for easy sharing of plumbing.

In a preferred embodiment, the lavatory monument assembly 40 is essentially a single lavatory monument that is mountable as a single unit in the interior of the cabin 102 and that includes both the first and second lavatories 42 and 44. As shown in FIGS. 7-7A, the lavatory monument assembly 40 includes first wall 16 that expands the usable space or volume of the second lavatory 44. As described above with the first embodiment, the first wall 16 can be locked or secured in either a stowed or expanded position. In a preferred embodiment, the first wall 16 includes a rotating wall that pivots about the inboard corner of the lavatory monument assembly 40 in order to increase the volume and footprint of the second lavatory 44. In a preferred embodiment, the first wall 16 can include hinges, latches, sliders and the like (referred to herein generally as movable portions 14) that allow the first wall 16 to move relative to the other walls. See, e.g., '669 patent, discussed above. In one embodiment, the pivoting wall 16 can include multiple panels or wall portions (e.g., first wall portion 16a and second wall portion 16b) that pivot and/or slide relative to one another (similar to the way a bi-fold door in a standard aircraft lavatory does) between expanded and stowed positions. As shown in FIGS. 7-7A, in a preferred embodiment, the first wall 16 includes a third wall portion 16c that is not movable. In another embodiment, the entire first wall 16 is movable. The door 26 can be part of one of the first, second or third wall portions 16a, 16b or 16c.

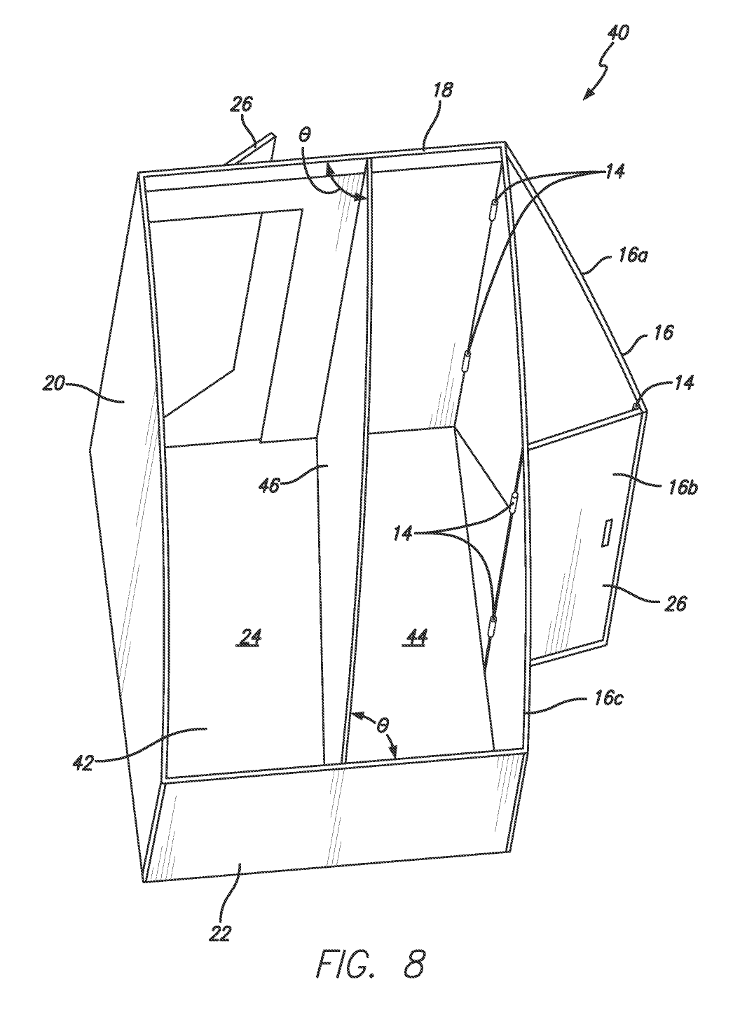

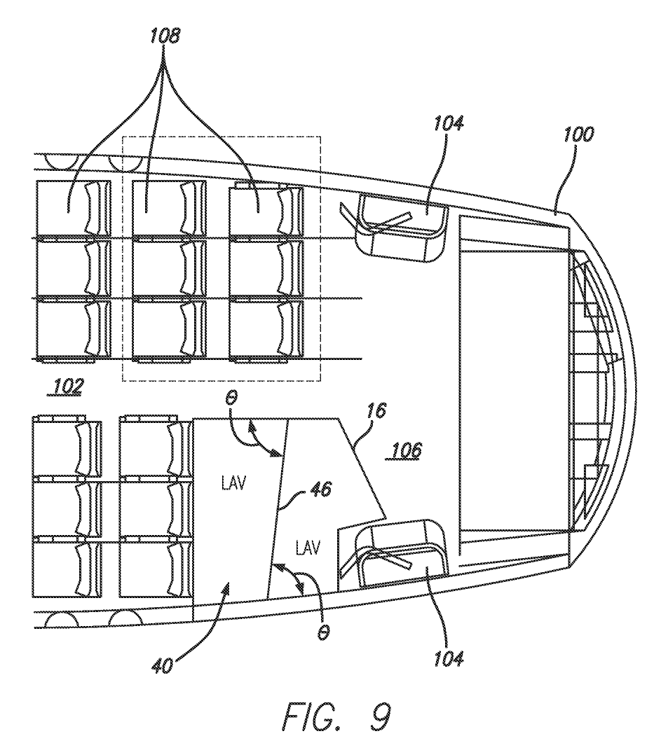

In a preferred embodiment, the lavatory monument assembly 40 is split by a non-horizontal panel or fifth wall 46 that is shared between the first and second lavatories 42 and 44. As shown in FIGS. 7-7A, in a preferred embodiment, the fifth wall 46 includes a first portion 46a that is parallel to the third wall 20 and a second portion 46b that is not parallel to and is positioned at an angle θ with respect to the first and third walls 16 and 20. In another embodiment, the entire fifth wall 46 can be parallel to the third wall 20. In yet another embodiment, as shown in FIGS. 8-9, the entire fifth wall 46 is not parallel to and is positioned at an angle θ with respect to the first and third walls 16 and 20. FIG. 8 shows the lavatory monument assembly 40 as having walls with the same height. However, it will be appreciated that in use, the lavatory monument assembly 40 can have walls shaped to fit within the cabin 102 of the aircraft 100. As will be appreciated by those skilled in the art, within the cabin of an aircraft, monuments are typically secured to attachment points, such as hard points and overhead and side attachments. Accordingly, a description of the attachment of the lavatory monument assembly will be omitted.

In an exemplary use of lavatory monument assembly 40, the first wall 16 is in the stowed position during taxi, takeoff and landing. In this position, the first and second lavatories 42 and 44 are usable, but space inside the second lavatory 44 is limited. After the aircraft has taken off and reached the desired height (typically 10,000 ft), a flight attendant or other person deploys the first wall 16, moves it from the stowed position (the first lavatory footprint) to the expanded position (the second lavatory footprint) and secures it in place. More space is now available in the second lavatory 44. When the aircraft is preparing for landing, a flight attendant or other person can once again move the first wall 16 to the stowed position.

As shown in FIG. 9, and as will be understood by those of ordinary skill in the art, that when the first wall 16 is in the expanded position, the second lavatory footprint extends into and overlaps with the exit corridor footprint 106. Accordingly, the lavatory monument assembly 40 utilizes space that is normally wasted during flight. However, when the first wall 16 is in the stowed position it does not overlap with the exit corridor footprint 106. This adheres to FAA emergency exit rules. In other words, the exit corridor footprint 106 is only partially blocked or overlapped when the aircraft is in flight. During taxi, takeoff and landing, the exit corridor footprint 106 is not partially blocked or overlapped.

Those of ordinary skill in the art will appreciate when the first wall 16 is in the stowed position, the footprint defined by the lavatory monument assembly 40 can be smaller than the footprint of two typical lavatories. When the lavatory monument assembly 40 is positioned in the aft of the cabin 102, as shown in FIG. 8, this allows the lavatory monument assembly 40 to be placed on one side of the cabin and a lavatory that is typically on the other side of the cabin to be eliminated, thus creating more space for extra seats 108, which can provide increased revenue for the owner of the aircraft. See, for example, the two rows of seats 108 that are surrounded by hidden lines in FIG. 9 to indicate that they have been added. Furthermore, as can be seen in FIGS. 7-7A, the angled toilet 28 orientation (see plane P1), and increased user space (see first and second passenger footprints F1 and F2) created when the first wall 16 is in the expanded position, allow for increased comfort and user space.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A lavatory monument assembly configured to be positioned in the interior of an aircraft, the lavatory monument assembly comprising:
first, second, third and fourth walls that cooperate to define a lavatory interior,
a door positioned on one of the first, second, third and fourth walls that allows access to the lavatory interior, and
a toilet positioned within the lavatory interior, wherein the toilet defines a first vertical plane that bifurcates the toilet, wherein the toilet is positioned such that the first vertical plane is not parallel to the first wall,
wherein at least the first wall is pivotal between a stowed position and an expanded position, wherein when the first wall is in the stowed position, the first, second, third and fourth walls define a first lavatory footprint, wherein when the first wall is in the expanded position, the first, second, third and fourth walls define a second lavatory footprint, and wherein the second lavatory footprint has a greater area than the first lavatory footprint.

2. The lavatory monument assembly of claim 1 wherein the first wall includes a first wall portion and a second wall portion, and wherein the first wall includes at least first, second and third movable portions, such that the first wall portion and the second wall portion are movable relative to one another.

3. The lavatory monument assembly of claim 2 wherein the door is positioned on the first or the second wall portion.

4. The lavatory monument assembly of claim 3 further comprising a sink positioned therein, wherein the sink is positioned on one or both of the second or third walls.

5. The lavatory monument assembly of claim 1 wherein the first wall includes an angled wall segment extending inwardly therefrom, wherein the angled wall segment is in slidable communication with the second wall, such that when the first wall is pivoted from the stowed position to the expanded position, the angled wall segment translates and slides relative to the second wall.

6. The lavatory monument assembly of claim 1 wherein when the first wall is in the stowed position a first passenger footprint is defined within the lavatory interior, wherein when the first wall is in the expanded position a second passenger footprint is defined within the lavatory interior, and wherein the second passenger footprint is larger than the first passenger footprint.

7. The lavatory monument assembly of claim 6 wherein the toilet is accessible to a passenger both when the first wall is in the expanded position and when the first wall is in the stowed position.

8. An aircraft comprising
a cabin having a side wall that includes at least one exit door, wherein the exit door includes an exit corridor adjacent thereto, and wherein the exit corridor includes an exit corridor footprint,
a lavatory monument assembly positioned within the cabin, wherein the lavatory monument includes first, second, third and fourth walls that cooperate to define a lavatory interior, a door positioned on one of the first, second, third and fourth walls that allows access to the lavatory interior, and a toilet positioned within the lavatory interior, wherein the toilet defines a first vertical plane that bifurcates the toilet, wherein the toilet is positioned such that the first vertical plane is not parallel to the first wall, wherein at least the first wall is pivotal between a stowed position and an expanded position, wherein when the first wall is in the stowed position, the first, second, third and fourth walls define a first lavatory footprint, wherein when the first wall is in the expanded position, the first, second, third and fourth walls define a second lavatory footprint, and wherein the second lavatory footprint has a greater area than the first lavatory footprint.

9. The aircraft of claim 5 wherein the lavatory monument assembly is positioned adjacent to the exit door, wherein the first wall defines a portion of the exit corridor, and wherein when the first wall is in the expanded position, the second lavatory footprint overlaps with the exit corridor footprint.

10. A method performed in the cabin of an aircraft, wherein the cabin includes a lavatory monument assembly positioned therein, wherein the cabin further includes a side wall with at least one exit door, wherein the exit door includes an exit corridor adjacent thereto, and wherein the exit corridor includes an exit corridor footprint, the method comprising the step of:
pivoting a first wall of the lavatory monument assembly between a stowed position and an expanded position, wherein when the first wall is in the stowed position, the lavatory monument assembly defines a first lavatory footprint, wherein when the first wall is in the expanded position, the lavatory monument assembly defines a second lavatory footprint, and wherein the second lavatory footprint has a greater area than the first lavatory footprint, wherein the lavatory monument assembly includes a toilet positioned therein, wherein the toilet defines a first vertical plane that bifurcates the toilet, wherein the toilet is positioned such that the first vertical plane is not parallel to the first wall when it is in the stowed position.

11. The method of claim 10 wherein when the first wall is in the expanded position, the second lavatory footprint overlaps with the exit corridor footprint.

12. The method of claim 11 wherein the first wall is in the stowed position during taxi, takeoff and landing and in the expanded position during the remainder of the flight.

13. The method of claim 12 wherein the toilet is accessible by a passenger when the first wall is in the stowed position and when the first wall is in an expanded position.

14. A lavatory monument assembly configured to be positioned in the interior of an aircraft, the lavatory monument assembly comprising:
first, second, third and fourth walls that cooperate to define a lavatory interior,
a fifth wall that spans between and is affixed to the second and fourth walls and that divides the lavatory interior into a first lavatory and a second lavatory,
a first door positioned on one of the first, second, third and fourth walls that allows access to the first lavatory,
a second door positioned on one of the first, second, third and fourth walls that allows access to the second lavatory,
wherein the first wall is pivotal between a stowed position and an expanded position, wherein when the first wall is in the stowed position, the first, second, third and fourth walls define a first lavatory footprint, wherein when the first wall is in the expanded position, the first, second, third and fourth walls define a second lavatory footprint, and wherein the second lavatory footprint has a greater area than the first lavatory footprint.

15. The lavatory monument assembly of claim 14 wherein the portion of the fifth wall that is affixed to the second wall is not parallel to the first wall when it is in the stowed position.

16. The lavatory monument assembly of claim 15 wherein a first portion of the fifth wall is not parallel to the first wall and a second portion of the fifth wall is parallel to the fifth wall.

17. The lavatory monument assembly of claim 14 wherein the first lavatory includes a first sink positioned therein and the second lavatory includes a second sink positioned therein, and wherein the first and second sinks are affixed to the fifth wall.

18. The lavatory monument assembly of claim 17 wherein the first and second sinks include shared plumbing.

19. The lavatory monument assembly of claim 14 further comprising a first toilet positioned in the first lavatory and a second toilet positioned in the second lavatory, wherein the second toilet defines a vertical plane that bifurcates the toilet, wherein the second toilet is positioned such that the vertical plane is not parallel to the first wall when it is in the stowed position.
